(19) United States
(12) Patent Application Publication
(10) Pub. No.: US 2026/0099566 A1
(43) Pub. Date: Apr. 9, 2026

(54) The Natural Universal PI (NU PI) Calculator

(71) Applicant: NU PI VENTURES LLC, Houston, TX (US)

(72) Inventors: Enrique Monterrosa, Houston, TX (US); Roberto Coello, Houston, TX (US); Jean Serge Joseph, Lake Worth Beach, FL (US)

(21) Appl. No.: 19/349,131

(22) Filed: Oct. 3, 2025

Related U.S. Application Data
(60) Provisional application No. 63/702,796, filed on Oct. 3, 2024.

(51) Int. Cl. G06F 17/11; G06F 17/18; G06F 17/40; G06F 40/18

(52) U.S. Cl. CPC G06F 17/11; G06F 17/18; G06F 17/40; G06F 40/18

(57) ABSTRACT

A computing device or system and methods used to calculate the value of one or more geometric measurements and comprises an additional key or formula bar that is configured to the value of Natural Universe PI (NU PI) or vπ. Inclusion of the value of NU PI in geometric calculations will increase the accuracy of these calculations. These geometric calculations have widespread applications including but not limited to space, aerospace, oil and gas, work place or home.

### REFERENCE TO RELATED PATENTS

The present application claims priority to the previously filed provisional application 63/702,796 filed on Oct. 3, 2024.

### FIELD OF THE INVENTION

The present invention, in general, relates to a device or a system that can calculate a range of geometric values that use the numerical value of pi (π), including but not limited to circumference of a circle, area of a disk, volume of a cylinder, volume of a cone, and volume of a sphere. Specifically, the present invention provides a more accurate numerical value for pi which the present invention refers to as Natural Universal PI or NU PI and is denoted by vπ. The use of NU PI in calculations will increase the accuracy of the above-mentioned geometric calculations.

### BACKGROUND

Calculations involving the numerical value of pi have many different applications in everyday life. Some examples of the applications where pi is used include, but are not limited to, for example, aligning satellites in the sky, assisting controllers in jet to drive motors to move actuators which control flaps that move aircraft wings and tails or parts that open or close on jet engines, calculating the size of cylindrical vessels in refineries, calculating the size of a roll of paper that will fit in a printer, calculating the volume of storage tanks and heaters, and similar such applications. The numerical value of pi, which is defined as the ratio of a circle's circumference to its diameter, used in each of these applications, is 3.14159 or approximately, 3.14. However, this value is not precise and using this value results in inaccurate calculations which may lead to failures in these highly complex systems. Indeed, deriving its definition in relation to the basis of the circle itself, pi is used in all areas concerned with circles, spheres and ellipses including all areas reliant upon geometry, trigonometry, and related fields, including physics, metaphysics, astronomy, mechanics, engineering, architecture, fractals, electromagnetics, thermodynamics, naming just a few.

Hence, there is a need for a more precise value of Pi that will help in obtaining more accurate values of the circumference of a circle, area of a disk, volume of a cylinder, volume of a cone, and volume of a sphere.

While the inventor has set forth the best mode or modes contemplated in carrying out the present invention known to the inventor, such as to enable a person skilled in the art to make and practice the present invention, the preferred embodiments are, however, not intended to be limiting, but are, on the contrary, included in a non-limiting sense apt to amendments, alterations, alternatives and modifications, in light of specification and appended claims forming the current disclosure.

### BRIEF SUMMARY OF THE INVENTION

A computing device or a computing system having a key or formula bar for Natural Universal PI or NU PI or, simply, vπ and is configured to use the value 3.1426968052735445528926416093549. This value is derived by calculating a precise correlation between a triangle, a square, a circle, and a straight line unit that is divided into a 9-digit system. This value will be used to calculate the circumference of a circle, area of a disk, volume of a cylinder, volume of a sphere, volume of a cone or similar calculations that require using the value of PI as now provided through NU PI. Also presented herein, is a method for calculating a geometric value or measurement that comprises entering one or more numerical values for the geometric value or measurement in the above-mentioned computing device or system, applying the values to a mathematical equation related to the geometric value or measurement, performing arithmetic operations on the values in the mathematical equations, and determining the value of the geometric measurement based on NU PI. The method also comprises developing charts, graphs, tables, and like data sets, based on the value of the geometric measurement thus obtained by the present invention.

In a preferred embodiment of the present invention is a method of determining effective volume of a spherical object. This method comprises:

predicting effective radius measurement of the spherical object that comprises obtaining effective measurement of diameter of the object along different axes; calculating an average effective diameter measurement based on the multiple diameter measurements; and determining an effective radius measurement of the object using the average diameter measurement;

predicting the effective volume of the object by multiplying cube value of radius measurement by Nu Pi and 4/3; and

storing the effective volume value in a memory device;

validating the effective volume value by comparing the effective volume value to a predetermined range of expected volume values;

flagging the effective volume value invalid if the value falls outside the predetermined range and separating this value; and

generating a report comprising the predicted effective measurement; the predicted effective volume value; the validation status of the predicted effective volume value; date and time of the prediction of the effective volume of the object, or a combination thereof.

The diameter measurement may not be the same throughout the object. Therefore, a person having ordinary skill in the art can weight the different measures depending on specific application and use the weighted diameter in their calculation. For instance, a cylindrical tank may bulge at the bottom due to liquid buildup or on top due to gas buildup. In that case, the average diameter will be a weighted diameter will depend on what the person of ordinary skill in the art is measuring.

In one embodiment of the preferred method, the method further comprises sending the effective volume of the object to a display device, a printer, a storage device, a remote computing device via a communication network or a combination thereof. In another embodiment of the preferred method, the Nu Pi value is 3.1426968052735445528926416093549, said value is derived by calculating a correlation between a triangle, a square, a circle, and a straight line unit that is divided into a 9-digit system. In yet another embodiment of the preferred method, the computing device comprises a key for Nu Pi. Examples of the computing devices include but are not limited to an electromechanical calculator, an electronic calculator or a digital calculator. In still yet another embodiment of the preferred method, the computing system comprises: a worksheet comprising plurality of rows and columns to enter, store, and organize data, wherein each of said rows and columns comprises plurality of cells; a formula bar to enter and edit mathematical expressions and functions, wherein the formula bar is configured to use the Nu Pi value of 3.1426968052735445528926416093549; a selection bar to select one or more of the rows, the columns, or the cells in the worksheet; and a sheet tab selector to organize each of the worksheets. Examples of the object whose effective volume is determined includes but is not limited to a dome-shaped structure, a curved structure, a circular structure or a spherical structure.

In another preferred embodiment of the present invention is a method of determining effective circumference of an object, comprising:
predicting effective measurement of the object, wherein said measurement includes at least one effective diameter measurement of the object or an effective radius measurement of the object;
predicting the effective circumference of the object by multiplying the effective diameter measurement by Nu Pi to obtain the effective circumference of the object on a computing device; or multiplying the effective radius measurement by two to obtain the diameter value, and then multiplying the diameter value by Nu Pi on a computing device or a computing worksheet to determine the effective circumference of the object; and
storing the effective circumference value in a memory device;
validating the effective circumference value by comparing the effective circumference value to a predetermined range of expected circumference values;
flagging the effective circumference value invalid if the value falls outside the predetermined range and separating the flagged effective circumference value; and

generating a report comprising the predicted effective measurement; the predicted effective circumference value; the validation status of the predicted effective circumference value; date and time of the prediction of the effective circumference of the object, or a combination thereof.

The measurement of the circumference will depend on the location of the cross-section of the object, which may not be the same throughout the object. Therefore, a person having ordinary skill in the art can weigh the different cross-section measures depending on specific application and use the weighted cross-section measures (e.g. diameter, radius) in their calculation.

In one embodiment of the preferred method, the method further comprises using the effective circumference to determine the effective surface area of the object, effective volume of the object or both. In another embodiment of the preferred method, the method further comprises sending the effective circumference of the object to a display device, a printer, a storage device, a remote computing device via a communication network or a combination thereof. In yet another embodiment of the preferred method, the Nu Pi value is 3.1426968052735445528926416093549, said value is derived by calculating a correlation between a triangle, a square, a circle, and a straight line unit that is divided into a 9-digit system. In still yet another embodiment of the preferred method, the computing device comprises a key for Nu Pi. Examples of the computing devices include but are not limited to an electromechanical calculator, an electronic calculator or a digital calculator.

In another embodiment of the preferred method, the computing system comprises a worksheet comprising plurality of rows and columns to enter, store, and organize data, wherein each of said rows and columns comprises plurality of cells; a formula bar to enter and edit mathematical expressions and functions, wherein the formula bar is configured to use the Nu Pi value of 3.1426968052735445528926416093549; a selection bar to select one or more of the rows, the columns, or the cells in the worksheet; and a sheet tab selector to organize each of the worksheets. Examples of the objects whose effective circumference value is determined include but is not limited to an object with a dome-shaped structure, a curved structure, a circular structure or a spherical structure.

In a preferred embodiment of the present invention is a computing device, where the device comprises one or more of a power source, a keypad for number and function commands, a display panel, a processor chip, one or more integrated circuits, ROM and/or RAM memories, or the like.

In one embodiment of the preferred computing device, the number commands comprise keys for digits 0-9 and an additional function key specific to the NU PI calculation.

In yet another embodiment of the preferred computing device, the NU PI functionality is integrated into calculations on a computing device without an outward facing interface (i.e., function key).

In another embodiment of the preferred computing device, the function key for NU PI is configured to use the value 3.1426968052735445528926416093549.

In yet another embodiment of the preferred computing device, the above-mentioned value is derived by calculating a correlation between a triangle, a square, a circle, and a straight line unit that is divided into a 9-digit system.

In still yet another embodiment of the preferred computing device, the key for NU PI may be configured to use the symbol vπ.

In further yet another embodiment of the preferred computing device, the NU PI key may be used in mathematical expressions to calculate values or measurements including but not limited to circumference of a circle, area of a disk, volume of a cylinder, volume of a sphere, volume of a cone or similar calculations that require use of pi as now present as NU PI. Examples of the computing device include but are not limited to electrochemical calculators, electronic calculators, digital calculators, or any other computational device or system that has the ability to calculate these measurements.

In another preferred embodiment of the present invention is a computing system, where the system comprises a worksheet that comprises plurality of rows and columns to enter, store, and organize data, where each of the rows and columns comprises plurality of cells, a formula bar to enter and edit mathematical expressions and functions, a selection bar to select one or more of the rows, the columns or the cells in the worksheet, and a sheet tab selector to organize each of the worksheets.

In one embodiment of the preferred computing system, the formula bar is configured to use the value for NU PI, where the value is 3.1426968052735445528926416093549.

In another embodiment of the preferred computing system, the formula bar is configured to use symbol vπ to represent NU PI functionality.

In yet another embodiment of the preferred computing system, the NU PI value is derived by calculating a correlation between a triangle, a square, a circle, and a straight line unit that is divided into a 9-digit system.

In yet another preferred embodiment of the present invention is a method for calculating a geometric value or measurement. This method comprises entering one or more numerical values for the geometric value or measurement in a computing device or system, applying the values to mathematical equation related to the geometric value or measurement, performing arithmetic operations on the values in the mathematical equation, and determining a geometric value or measurement.

In one embodiment of the preferred method, the computing device comprises one or more of a power source, a keypad for number and function commands, a display panel, a processor chip, one or more integrated circuits, ROM and/or RAM, or similar memory functionality.

In another embodiment of the preferred method, number commands comprise keys for digits 0-9, and an additional key for NU PI, where the key for NU PI is configured to use value 3.1426968052735445528926416093549, whereby the value is derived by calculating a correlation between a triangle, a square, a circle, and a straight line unit that is divided into a 9-digit system.

In yet another embodiment of the preferred method, the key for NU PI is configured to use term vπ. Examples of the computing device include but are not limited to electrochemical calculator, electronic calculator, digital calculator, or any other device or system that has the ability to calculate these measurements.

In another embodiment of the preferred method, the computing system comprises a worksheet comprising plurality of rows and columns to enter, store, and organize data, wherein each of said rows and columns comprises plurality of cells, a formula bar to enter and edit mathematical expressions and functions, a selection bar to select one or more of the rows, the columns, or cells in the worksheet, and a sheet tab selector to organize each of the worksheets.

In yet another embodiment of the preferred method, the formula bar is configured to use the value for NU PI, wherein the value is 3.1426968052735445528926416093549, whereby the value is derived by calculating a precise correlation between a triangle, a square, a circle, and a straight line unit that is divided into a 9-digit system.

In still yet another embodiment of the preferred method, the formula function bar is configured to use symbol vπ.

In further yet another embodiment of the preferred method, the geometric value or measurement calculated is circumference of circle, area of a disk, volume of a cylinder, volume of a sphere, volume of a cone or similar calculations that require use of NU PI. Examples of arithmetic operations include but is not limited to addition, subtraction, multiplication, division, or a combination thereof.

### BRIEF DESCRIPTION OF THE DRAWINGS

So that the manner in which the present invention can be better understood, certain illustrations, charts and/or flow charts are appended hereto. It is to be noted, however, that the drawings illustrate only selected embodiments of the inventions and are therefore not to be considered limiting of scope, for the inventions can admit to other equally effective embodiments and applications.

Moreover, advantages and other aspects of the invention will be readily appreciated by those persons having skill in the art and may be better understood with further reference to the accompanying drawings in which like reference characters designate like or similar elements throughout the several figures of the drawings and wherein:

FIG. 1 illustrates frontal view of the calculator that has an additional function key for NU PI or vπ.

FIG. 2A illustrates an exemplary worksheet or spreadsheet with the formula to calculate the hypotenuse and the circumference of the circle, where the circumference is calculated using the numerical value of NU PI or vπ instead of the pi. FIG. 2B illustrates an exemplary worksheet or spreadsheet with the value of the hypotenuse and the circumference of the circle, where the circumference is calculated using the numerical value of NU PI or vπ. FIG. 3 illustrates the correspondence between the 10-digit system (numbers on the left) and the 9-digit system (numbers on the right).

FIG. 4 illustrates construction of the hypotenuse of length \sqrt{2} from perpendicular unit segments using the Pythagorean theorem.

FIG. 5 illustrates a right triangle with each leg length of \sqrt{2}/2 and the hypotenuse of length 1 using the Pythagorean theorem.

FIG. 6 illustrates a square with each side of length \sqrt{2}/2 and diagonal of length 1 formed when the right triangle is reflected about the hypotenuse. FIG. 7 illustrates a circle with the diameter of length 1 (unit circle) generated by connecting the corners of the square.

FIG. 8 illustrates the circumference of a unit circle computed in the 9-digit system.

FIG. 9 illustrates a regular decagon inscribed in a unit circle with the length of each side equal to

$$\frac{2}{9} \sqrt{2} .$$

FIG. 10 illustrates a regular icosagon inscribed in a unit circle with the length of each side equal to

$$\frac{1}{9} \sqrt{2} .$$

FIG. 11 illustrates a circle of diameter d\sqrt{2} generated by rotating a square of side length d around the midpoint of the diagonal.

FIG. 12 illustrates a sphere with a diameter of d\sqrt{3} generated by rotating around a cube with side of length d around the midpoint of its diagonal.

FIG. 13 is a table with lengths of the diagonals calculated for side lengths 1 to 10 and dimensions 2 to 11.

FIG. 14 illustrates a right triangle with side of length d and a hypotenuse of length d\sqrt{2}.

FIG. 15 illustrates volume ratio of π-volume and vπ (NU PI)-volume very close to 100%. Not plotted to scale.

FIG. 16 is a table showing volume ratio when the regular diameter is between 1,000,000 and 1,000,008.

FIG. 17 is a table showing volume ratio when the Pythagorean diameter is between 1,414,213 and 1,414,225.

FIG. 18 is a table showing the difference for regular diameters between 1,000,000 and 1,000,008.

FIG. 19 is a table showing the difference for Pythagorean diameters between 1,414,213 and 1,414,225.

FIG. 20 is a graph showing that the consecutive ratio approaches 1 for large diameters. Not plotted to scale.

FIG. 21 is a table showing the consecutive ratio for regular diameters between 1,000,000 and 1,000,008.

FIG. 22 is a table showing the consecutive ratio for Pythagorean diameters between 1,414,213 and 1,414,225.

FIG. 23 is a flow chart that illustrates the method of determining effective measurement value of an object using the NU PI value derived in the present application. Examples of measurement value include but are not limited to effective volume, effective circumference, and effective surface area or any other measurement value that uses the value of NU PI.

However, it should be understood that the above described figures are not intended to be limited to only the invention illustrated and to the particular embodiments disclosed, but on the contrary, the intention is intended to disclose all modifications, alternatives and equivalents falling within the spirit and scope of the invention as defined within the claim's broadest reasonable interpretation consistent with the specification.

### DETAILED DESCRIPTION OF THE PREFERRED EMBODIMENTS

A detailed description of the preferred embodiments of the invention is disclosed and described below. Yet, each and every possible feature, within the limits of the specification, are not disclosed as various iterations are postulated to be in the purview and contemplation of those having skill in the art. It is therefore possible for those that have requisite skill in the art to make and practice the disclosed invention while observing that certain features and spatial arrangements are relative and capable of being scaled, adapted, arranged at various points about the present invention (by inventor, manufacturer or both) that nonetheless accomplishes the remediation of one or more of the infirmities as outlined and discussed above in the field of computing system or device design and use. As well, individual components of the present invention may be sized (i.e. enlarged or shrunken) so long as the proportions are maintained that allow for maintaining of esthetic appearance and proper functioning of the present invention.

Equally, it should be observed that the present invention can be understood, in terms of structure, function, or both, from the present disclosure as well as those appended claims taken in context with the associated drawings. And whereas the present invention and method of use are capable of several different embodiments and permutations, which can be modified into several different configurations, each exhibiting accompanying interchangeable functionalities, without departing from the scope and spirit of the present application as shown and described.

The present invention discloses a value termed as Natural Universal PI or NU PI or πx, which is a constant that can be used as substitute for the constant PI (π). This constant NU PI is between the Archimedean bounds and is very close to the value of π. The derivation of NU PI uses basic Euclidean geometry and the correspondence between a 10-digit system and 9-digit system. An alternative derivation uses regular polygon with diminishing side lengths. A computing device or system will use NU PI to more accurately calculate a wide range of values for measurements including but not limited to the circumference of a circle, area of a disk, volume of a cylinder, volume of a cone, and volume of a sphere.

Although the vπ value disclosed herein is very close to the π value, incorporation of the vπ value in the formulas that use the π value results in more accurate measurement value as disclosed herein. The utility of the vπ value includes but is not limited to a calculator, multidimensional communicator, educational applied mathematics, software/spreadsheet, gravity calculator, time dilation calculator, geometry educator, numbers 2 art creator, numbers 2 color creator, universal patterns recognition calculator, interplanetary educator, multidimensional communicator, interdimensional communicator, memory retention calculator/measurer, geospatial locator, pinpoint from one side of the sphere to the other, can be from 0 to the complete observable universe or beyond, time calculator, quantum communicator, spherical properties calculator, and design and CAD software applications for design.

### Derivation of NU PI

### Correspondence Between a 10-Digit System and a 9-Digit System

A 10-digit system is a number system where all the numbers are composed of digits {1,2,3,4,5,6,7,8,9,10}. Further, a 9-digit number system is composed of digits {1,2,3,4,5,6,7,8,9}.

A correspondence between these two number systems is defined as follows: A segment is subdivided into 10 subsegments of equal length. Each segment is labeled with the digits of the 10-digit system (FIG. 3) and each split between any two consecutive subsegments with the digits of the 9-digit system.

### Derivation of \sqrt{2}

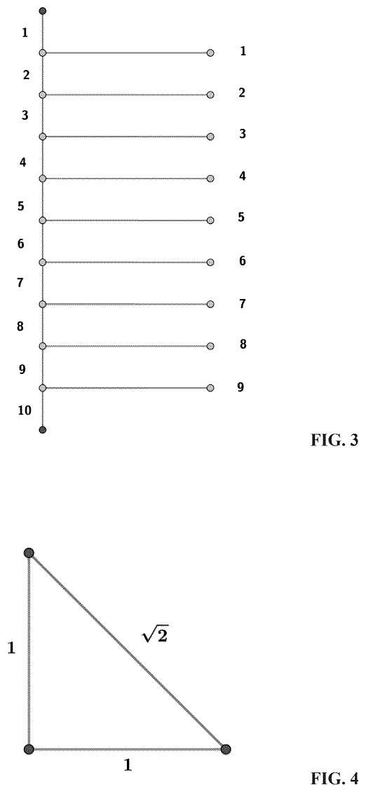

A segment of unit length formed by connecting two points is taken. Then two such segments are joined in one common endpoint so that the segments are perpendicular. Then a hypotenuse is drawn to form a right triangle. The Pythagorean theorem gives the length of the hypotenuse to be \sqrt{1²+1²}=\sqrt{2} (FIG. 4).

### Construction of the Unit Circle

To construct a unit circle, a right triangle with the hypotenuse of length l is constructed (FIG. 5). Next, the right triangle is reflected about the hypotenuse to create a square with each side of length

$$\frac{\sqrt{2}}{2}$$

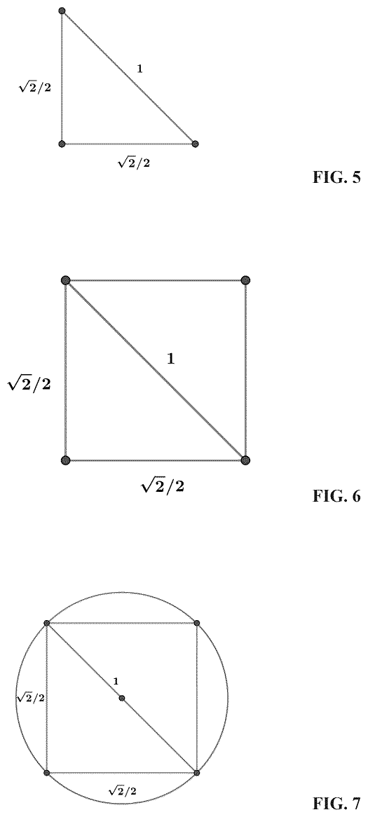

as shown in FIG. 6. Further, the square is rotated by 90° (clockwise or anticlockwise). The corners of the square generate a circle with the diagonal of the square being the diameter of the circle (FIG. 7).

### Computing the Circumference of the Unit Circle

In the 10-digit system, the smallest value 1 unit can be divided into is 1/10 because 10 is the largest number. Similarly, in the 9-digit system, the smallest value 1 unit can be divided into is 1/9 because 9 is the largest number.

The diagonal, square and circle are subdivided with parallel lines as shown in Figure F. Since the length of the diagonal is 1, the 10-digit system is used to label the 10 equal subsegments of the diagonal. Since the length of each subsegment is 1/10, each subsegment has the smallest length. This labeling of the diagonal yields a labeling of the circle in the 9-digit system via the correspondence between the 10-digit system and the 9-digit system (see FIG. 3).

Taking into consideration one half circle, the combined length of the two sides of the square that share a common endpoint is

$$\frac{\sqrt{2}}{2} + \frac{\sqrt{2}}{2} = \sqrt{2} .$$

The lines that pass through the splits labeled 1/9, 2/9, 3/9, . . . , which are perpendicular to the magenta diameter of the circle (or the diagonal of the square), mark the sides of the square and the circle that inscribes the square (FIG. 8). In the 9-digit system, the smallest length of the side of the square is measured from the perspective of the diagonal and equals 1/9, while the smallest length of the circle is measured from the perspective of the two sides of the square that share the common endpoint and equals

$$\frac{\sqrt{2}}{9} .$$

To measure the length of the sides of the square, one projects the sides of the square onto the diagonal along the lines perpendicular to the diagonal. Similarly, to measure the length of the half-circle, one projects the half-circle onto the sides of the square along the lines perpendicular to the diagonal. Since these lines split each side of the square into 5 pieces and each side corresponds to a quarter of the circle, the circumference of the half circle in the 9-digit system is

$$2 ( 5 ( \frac{\sqrt{2}}{9} ) ) .$$

Thus, the circumference of the circle (made of two half-circles) is

$$2 ( 2 ( 5 ( \frac{\sqrt{2}}{9} ) ) ) = 20 \frac{\sqrt{2}}{9} = νπ$$

or NU PI. Therefore, Nu PI or vπ is the circumference of the unit circle in the 9-digit system.
Computing the Circumference of the Unit Circle with Regular Polygons

Another way to compute the circumference of the unit circle is to inscribe regular polygons in it and increase the number of sides until the polygons coincide with the circle. One example is where a regular decagon is inscribed in the unit circle where each side of the decagon is

$$\frac{2}{9} \sqrt{2}$$

as shown in FIG. 9. The perimeter of the decagon is the number of sides (10) times the length of the side, which equals to

$$10 ( \frac{2}{9} \sqrt{2} ) = \frac{20}{9} \sqrt{2} = νπ$$

### or NU PI.

Yet another way is to inscribe a regular icosagon in the unit circle, where the length of each side is

$$\frac{1}{9} \sqrt{2}$$

as shown in FIG. 10. The perimeter of the icosagon is the number of sides (20) times the length of a side, which equals to

$$20 ( \frac{1}{9} \sqrt{2} ) = \frac{20}{9} \sqrt{2} = νπ$$

### or NU PI.

This process can be iterated by inscribing regular polygons with number of sides in the multiples of 10 and number of sides in the multiples of 20, in the unit circle. When the number of sides of the regular polygon is a multiple of 10, the perimeter of the polygon is

$${p}_{k} = 10 k \times \frac{\frac{2}{k}}{9} \sqrt{2} = \frac{20}{9} \sqrt{2} = νπ$$

or NU PI, where k=1,2,3, . . .
When the number of sides of the regular polygon is a multiple of 20, the perimeter of the polygon is

$${p}_{k} = 20 k \times \frac{\frac{1}{k}}{9} \sqrt{2} = \frac{20}{9} \sqrt{2} = νπ$$

or NU PI, where k=1,2,3, . . .
In both cases, the perimeter of the regular polygons is always vπ or NU PI as the number of sides increases infinitely. With very large number of sides, the polygons coincide with the unit circle, so the perimeter of the unit circle is vπ or NU PI.

### Higher Dimensions

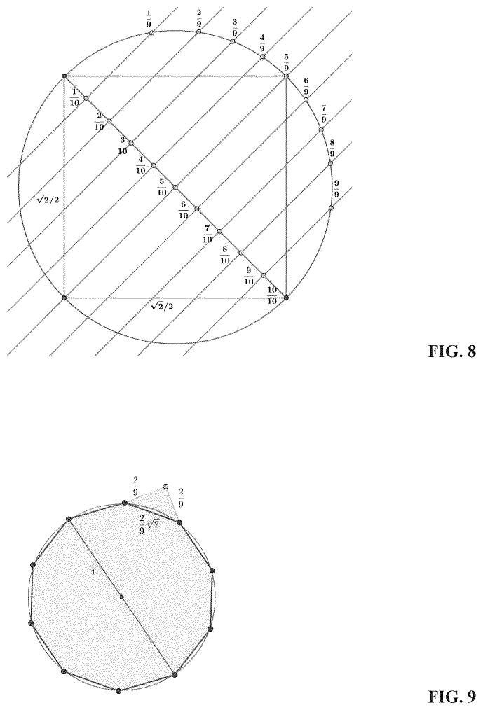

In the 2-dimensional case, when the square of side of length d is rotated around the midpoint of its diagonal, the four corners of the square generate a circle of diameter equal to the length of the diagonal, which is d\sqrt{2} as shown in FIG. 11.

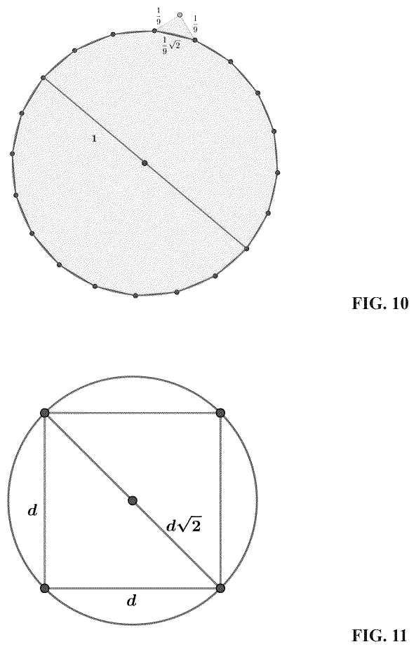

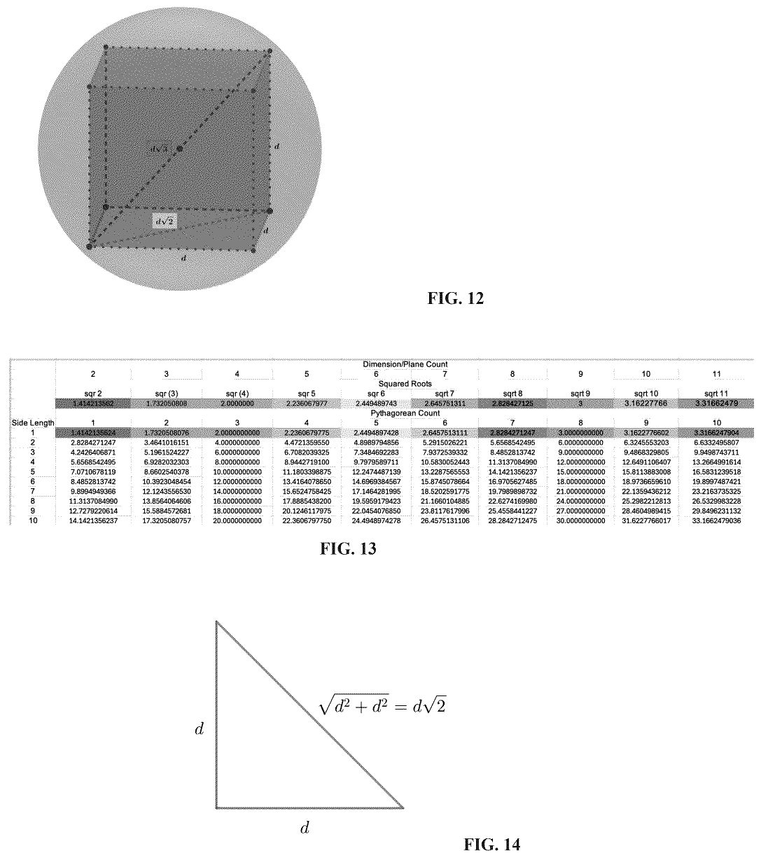

In the 3-dimensional case, a cube of side of length d is rotated in all directions around the midpoint of the diagonal. The corners of the cube generate a sphere with a diameter equal to the length of the diagonal of the cube, which is d\sqrt{3} as shown in FIG. 12.

This process can be extended to higher dimensions as shown in FIG. 13. In the n-dimensional case, a cube with side of length d has a diagonal of length d\sqrt{n}. The cube generates a sphere of diameter equal to the length of the diagonal of the cube.

Calculation of Volume using vπ or NU PI

In this section, the volume of a sphere is calculated using π and vπ and the two volumes are compared with each other. The π-volume of a sphere is the number

$$\frac{4}{3} π {R}^{3} ,$$

where R is the radius of the sphere. The vπ-volume of a sphere is the number

$$\frac{4}{3} ( νπ ) {R}^{3} .$$

As π and vπ are close to each other, it is expected that these two volumes will be close to each other. However, as the size of the sphere increases, its π-volume and vπ-volume may considerably diverge. In order to understand how the differences between these volumes evolve as the sphere increases in size, a number of metrics that capture various aspects of the difference between the volumes are defined and the behavior of these volumes as the diameter of the sphere increase is studied. To do so, two types of diameters: regular and Pythagorean are considered. Regular diameters are diameters with integer values 1, 2, 3, . . . and Pythagorean diameters are lengths of the hypotenuses of right triangles with integer sides, where the lengths are calculated based on the Pythagorean theorem (FIG. 14). There is a natural relationship between a regular diameter and a Pythagorean diameter: a regular diameter d, the corresponding Pythagorean diameter is d\sqrt{2}.

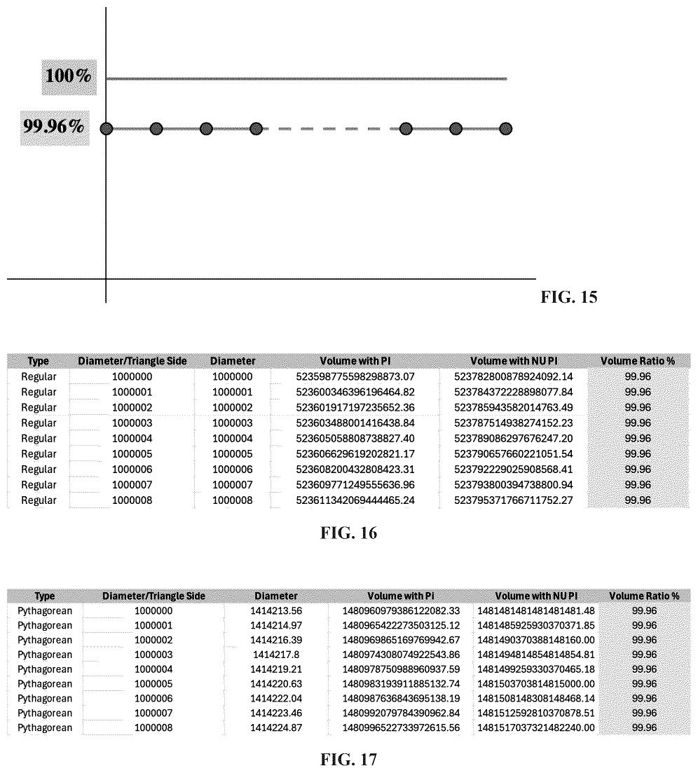

The first metric is the volume ratio, which is defined as the percentage of the π-volume divided by the vπ-volume and is calculated using the formula π-volume divided by vπ-volume then multiplied by 100. The volume ratio equals 99.96% for any diameter, in particular for large diameters. This shows that the π-volume is very close to the vπ-volume regardless of the size of the sphere. (FIGS. 15-17).

The second metric is the difference and that is the difference between the values for vπ-volume and π-volume. The difference for any diameter is always positive, showing that the vπ-volume for any sphere is always greater than the π-volume for the sphere with the same diameter.

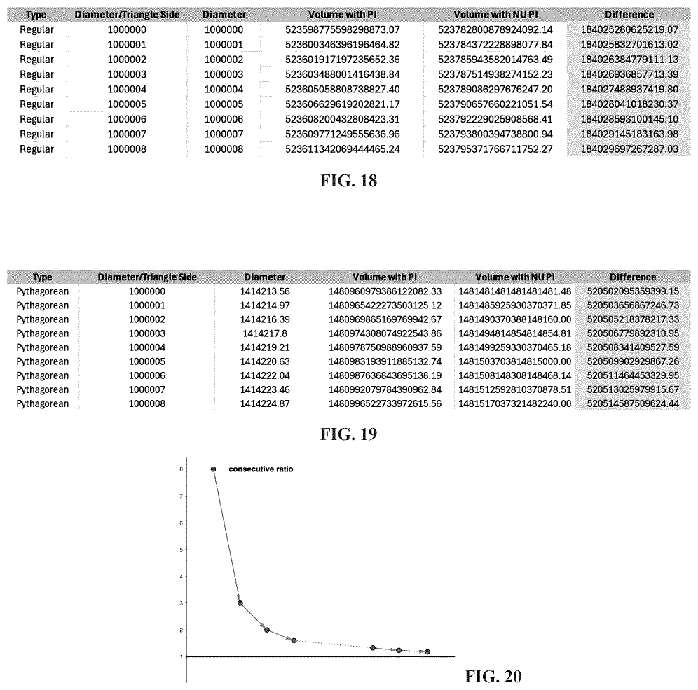

Furthermore, the difference increases as the diameter increases which also means that larger spheres have larger gaps between their vπ-volume and π-volume (FIGS. 18-19).

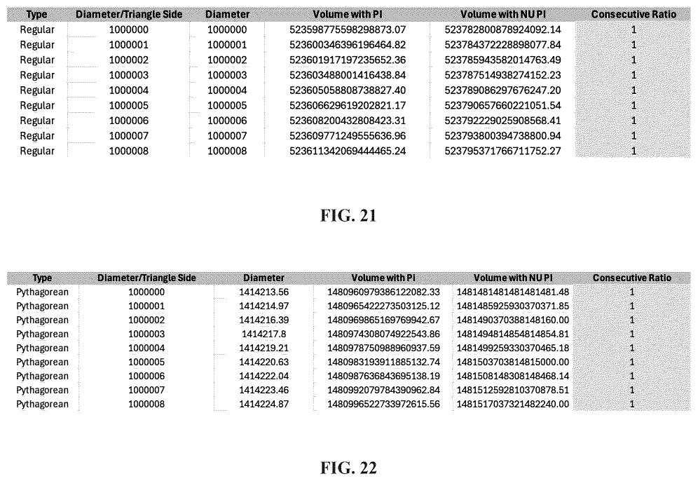

The third metric is the consecutive ratio that computes the ratio of consecutive differences, with the greater difference being the numerator. The consecutive ratio gives the proportion of the smaller difference in the larger difference. As the diameter increase, the consecutive ratio approaches 1, which shows that the gap between the π-volume and the vπ-volume stabilizes as the sphere gets larger (FIGS. 20-22)

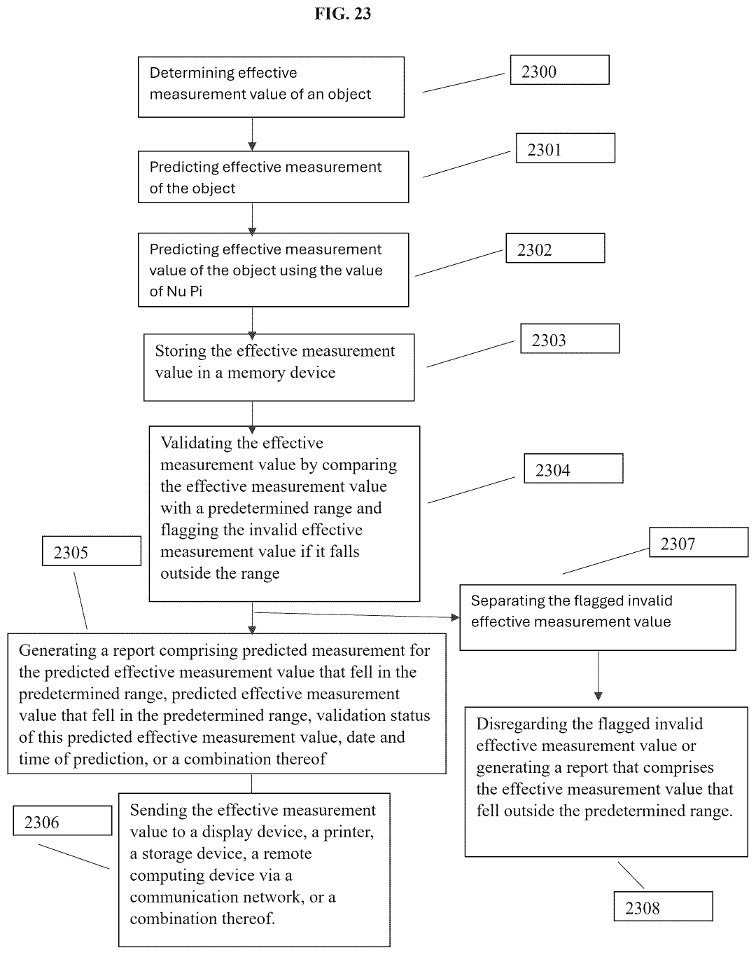

FIG. 23 is a flowchart illustrating the steps involved in calculating effective measurement 2300 (for e.g. circumference, volume, surface area, etc.) of an object. The term “effective measurement” is defined as the weight applied to different measurements by the person of ordinary skill in the art depending on the application. First, the measurement of the object is predicted by measuring various parameters, including but not limited to length, height, radius, or diameter by standard means 2301. In this case the person of ordinary skill in the art will apply weight to the different measurements depending on the specific application. Based on the formula for effective measurement value comprising vπ value, values for the different parameters are incorporated and the effective measurement value of the object is predicted 2302. For example, one can substitute the value of π with the vπ value in the formula that includes but is not limited to the formula to determine circumference, volume, or surface area. This effective measurement value is stored in a memory device 2303 and then validated by comparing with a predetermined range. Invalid effective measurement value 2304, i.e. the effective measurement value that falls outside the range is flagged and separated while the effective measurement value that falls within the predetermined range is incorporated in a report 2305 that comprises predicted effective measurement value that fell within the predetermined range and the measurement value for this effective measurement value, validation status of the predicted effective measurement value, date and time of prediction or a combination thereof. The report is then sent to a display device, a printer, a storage device, a remote computing device via a communication network or a combination thereof 2306. The effective measurement value that falls outside of the predetermined range is flagged and separated 2307 and the flagged effective measurement value is disregarded 2308 or included in a report that comprises such disregarded effective measurement value, along with the measurement of the object for that value, validation status, date and time of prediction or a combination thereof (not shown).

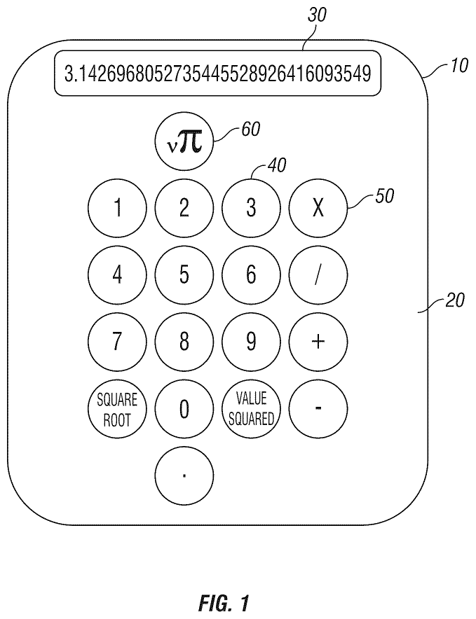

As detailed in FIG. 1, the computing device or calculator 10 has a keypad 20 for 0-9 number commands 40a, 40b, 40c, . . . (collectively referred to as number command 40). The function commands such as multiplication, division, addition, subtraction, square root, value squared, and decimal point on the keypad 20 are referred to by 50a, 50b, 50c, . . . (collectively referred to as function command 50). In addition to these keys, there is a function key for NU PI or vπ 60. It is understood that although the figure illustrates the position of NU PI or vπ 60 on top of all the other keys, the position of this key may vary depending on operator proclivity, ergonomics, functional component orientation, necessity, or the manufacturer of the computing device. Similarly, the positions of the number command 40 and function command 50 may vary depending on the manufacturer of the computing device and may include commands, shortcut keys or functional keys with reflect the country or territory of the operator and/or regional dialects.

The calculator 10 also has display panel 30 that allows the user to view the numbers and operations as he enters them in the computing device or calculator 10. The display panel 30 in FIG. 1A shows the numerical value of NU PI or vπ.

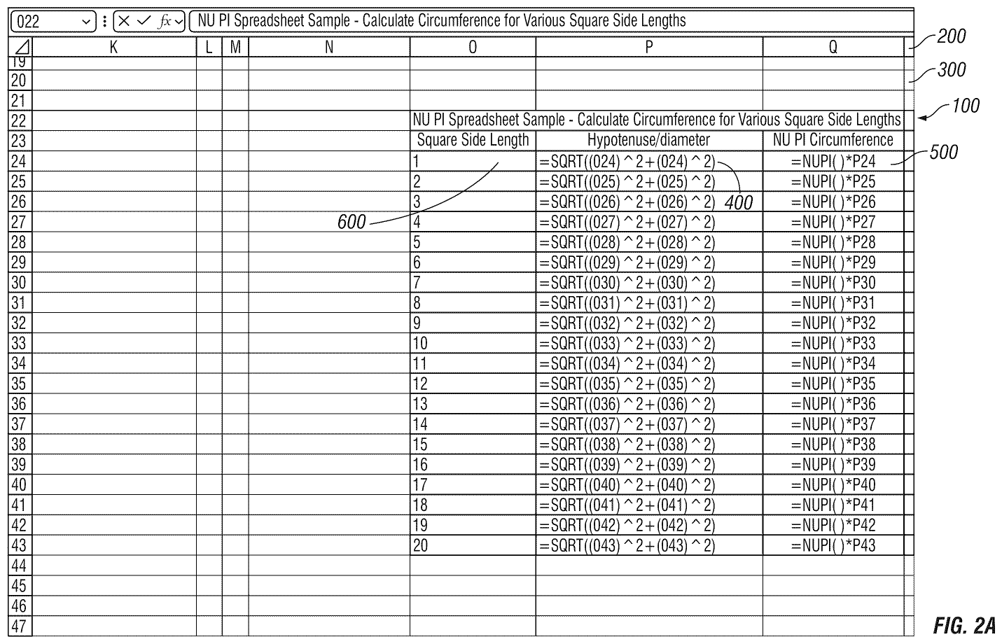

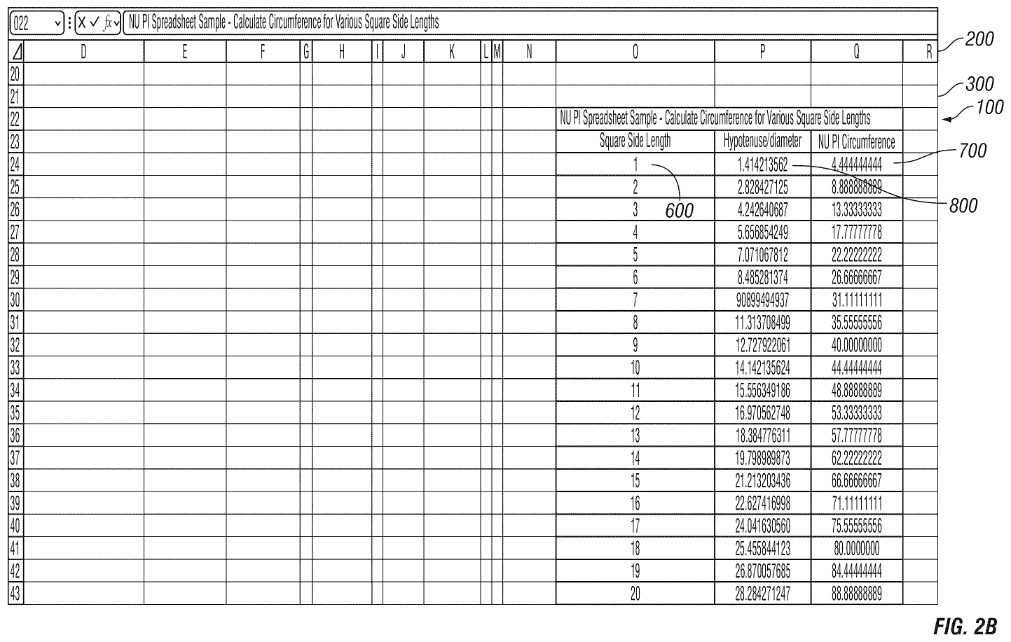

The computing device or calculator 10 may be of different sizes, shapes, and colors. They also may be made of different materials including but not limited to plastics, aluminum, or other similar materials. The computing device or calculator 10 illustrated herein may be a simple arithmetic calculator, scientific calculators, or any like calculators, that can perform advanced scientific functions, graphing calculator, and specialized calculators for engineering. FIG. 2A illustrates the exemplary spreadsheet or worksheet 100 with rows 20, 21, 22, . . . referred to as 300a, 300b, 300c, . . . (collectively referred to as row 300) and columns K, L, N, . . . referred to as 200a, 200b, 200c, . . . (collectively referred to as column 200). The spreadsheet or worksheet 100 has columns configured for length of side of square 600, for the formula to calculate the hypotenuse/diameter 400, and for the formula to calculate NU PI circumference 500. The formula bar in this worksheet or spreadsheet 100 includes the numerical value 3.1426968052735445528926416093549 for NU PI or vπ. FIG. 2B illustrates the exemplary spreadsheet or worksheet 100 with row 300 and column 200 (as described above) with values after the user has used the formulas described in FIG. 1A. The length of side of square 600 is used to calculate the hypotenuse/diameter 800, which is then applied to mathematical equation that has the value of NU PI or vπ to obtain the value of circumference 700.

Although the spreadsheet or worksheet 100 here illustrates how to calculate the circumference of a circle, it is understood that the spreadsheet or worksheet 100 can be used to calculate other values including but not limited to area of a disk, volume of a cylinder, volume of a sphere, volume of a cone or similar calculations that require use of NU PI. Additionally, these values can be used to plot graphs, tables, diagrams and other like representations of formulae.

Although only a select few example embodiments have been described in detail above, those skilled in the art will readily appreciate that many modifications are possible in the example embodiments without materially departing from this disclosure of the invention. Accordingly, all such modifications are intended to be included within the scope of this disclosure as defined in the appended claims.

What is claimed is:

1. A method of determining effective volume of a spherical object, comprising:
predicting effective radius measurement of the spherical object, comprising:
obtaining measurement of diameter of the object along different axes;
calculating an average effective diameter measurement based on the multiple diameter measurements; and
determining an effective radius measurement of the object using the average diameter measurement;
predicting the effective volume of the object by:
multiplying cube value of effective radius measurement by Nu Pi and 4/3; and
storing the effective volume value in a memory device;
validating the effective volume value by:
comparing the effective volume value to a predetermined range of expected volume values;
flagging the effective volume value invalid if the value falls outside the predetermined range; and
separating the invalid effective volume value from the valid effective volume value; and
generating a report comprising:
the predicted effective measurement;
the predicted effective volume value;
the validation status of the predicted effective volume value;
date and time of the prediction of the effective volume of the object, or a combination thereof.

2. The method of claim 1, further comprising:
sending the effective volume of the object to a display device, a printer, a storage device, a remote computing device via a communication network or a combination thereof.

3. The method of claim 1, wherein the Nu Pi value is 3.1426968052735445528926416093549, said value is derived by calculating a correlation between a triangle, a square, a circle, and a straight line unit that is divided into a 9-digit system.

4. The method of claim 1, wherein the computing device comprises a key for Nu Pi, wherein said computing device is an electromechanical calculator, an electronic calculator or a digital calculator.

5. The method of claim 1, wherein the computing system comprises:
a worksheet comprising plurality of rows and columns to enter, store, and organize data, wherein each of said rows and columns comprises plurality of cells;
a formula bar to enter and edit mathematical expressions and functions, wherein the formula bar is configured to use the Nu Pi value of 3.1426968052735445528926416093549;
a selection bar to select one or more of the rows, the columns, or the cells in the worksheet; and
a sheet tab selector to organize each of the worksheets.

6. The method of claim 1, wherein the object is a dome-shaped structure, a curved structure, a circular structure or a spherical structure.

7. A method of determining effective circumference of an object, comprising:
predicting effective measurement of the object, wherein said measurement includes at least one of an effective diameter measurement of the object or an effective radius measurement of the object;
predicting the effective circumference of the object by:
multiplying the effective diameter measurement by Nu Pi to obtain the effective circumference of the object on a computing device; or
multiplying the effective radius measurement by two to obtain the effective diameter value, and then multiplying the effective diameter value by Nu Pi on a computing device or a computing worksheet to determine the effective circumference of the object; and
storing the effective circumference value in a memory device;
validating the effective circumference value by:
comparing the effective circumference value to a predetermined range of expected circumference values;
flagging the effective circumference value invalid if the value falls outside the predetermined range; and
separating the invalid effective circumference value from the valid effective circumference value; and
generating a report comprising:
the predicted effective measurement;
the predicted effective circumference value;
the validation status of the predicted effective circumference value;
date and time of the prediction of the effective circumference of the object,
or a combination thereof.

8. The method of claim 7, further comprising:
using the effective circumference to determine the effective surface area of the object, effective volume of the object or both.

9. The method of claim 7, further comprising:
sending the effective circumference of the object to a display device, a printer, a storage device, a remote computing device via a communication network or a combination thereof.

10. The method of claim 7, wherein the Nu Pi value is 3.1426968052735445528926416093549, said value is derived by calculating a correlation between a triangle, a square, a circle, and a straight line unit that is divided into a 9-digit system.

11. The method of claim 7, wherein the computing device comprises a key for Nu Pi, wherein said computing device is an electromechanical calculator, an electronic calculator or a digital calculator.

12. The method of claim 7, wherein the computing system comprises:
a worksheet comprising plurality of rows and columns to enter, store, and organize data, wherein each of said rows and columns comprises plurality of cells;
a formula bar to enter and edit mathematical expressions and functions, wherein the formula bar is configured to use the Nu Pi value of 3.1426968052735445528926416093549;
a selection bar to select one or more of the rows, the columns, or the cells in the worksheet; and
a sheet tab selector to organize each of the worksheets.

13. The method of claim 7, wherein the object is a dome-shaped structure, a curved structure, a circular structure or a spherical structure.

14. A computing device, said device comprising one or more of:
a power source;
a keypad for number and function commands, wherein the number commands comprise keys for digits 0-9 and an additional key for NU PI, said NU PI key is configured to use value of 3.1426968052735445528926416093549;
a display panel;
a processor chip;
one or more integrated circuits; and
RAM

15. The computing device of claim 14, wherein the Nu Pi value is derived by calculating a correlation between a triangle, a square, a circle, and a straight line unit that is divided into a 9-digit system.

16. The computing device of claim 14, wherein said device is an electrochemical calculator, electronic calculator, or a digital calculator.

17. The computing device of claim 14, wherein the Nu Pi value is used in mathematical expressions to determine effective measurements of circumference, surface area, and volume.

18. A computing system, said system comprising:
plurality of rows and columns to enter a worksheet comprising plurality of rows and columns to enter, store, and organize data, wherein each of said rows and columns comprises plurality of cells;
a formula bar to enter and edit mathematical expressions and functions, wherein the formula bar is configured to use the Nu Pi value of 3.1426968052735445528926416093549;
a selection bar to select one or more of the rows, the columns, or the cells in the worksheet; and
a sheet tab selector to organize each of the worksheets.

19. The computing system of claim 18, wherein the Nu Pi value is derived by calculating a correlation between a triangle, a square, a circle, and a straight line unit that is divided into a 9-digit system.

20. The computing system of claim 19, wherein the Nu Pi value is used in mathematical expressions to determine effective measurements of circumference, surface area, and volume.
